(19) United States
(12) Patent Application Publication
(10) Pub. No.: US 2014/0178862 A1
(43) Pub. Date: Jun. 26, 2014

(54) PHOTOINDUCED REDOX CURRENT (PIRC) DETECTION FOR DNA SEQUENCING USING INTEGRATED TRANSDUCER ARRAY

(71) Applicants: Xing Su, Cupertino, CA (US); Handong Li, San Jose, CA (US)

(72) Inventors: Xing Su, Cupertino, CA (US); Handong Li, San Jose, CA (US)

(21) Appl. No.: 13/721,488

(22) Filed: Dec. 20, 2012

(51) Int. Cl. G01N 27/00

(52) U.S. Cl. CPC G01N 27/00
USPC 435/6.1; 435/287.2

(57) ABSTRACT

Photoinduced redox current (PIRC) detection for DNA sequencing using integrated transducer arrays is described. For example, a method of determining DNA sequencing using photoinduced redox current (PIRC) includes providing a template having a primer region and a second region of one or more unknown bases. The template is coupled to a transducer array. The method also includes incorporating a tagged nucleotide at the second region of the template. The method also includes exposing the template to a light source. The method also includes electrically detecting, by the transducer, a state of the template. The method also includes removing a photosensitizer tag of the tagged nucleotide.

### TECHNICAL FIELD

Embodiments of the invention are in the field of devices and methods for detection of biomolecules such as analytes and, in particular, photoinduced redox current (PIRC) detection for DNA sequencing using integrated transducer arrays.

### BACKGROUND

DNA sequencing is in the throes of an enormous technological shift marked by dramatic throughput increases, a precipitously dropping per-base cost of raw sequence, and an accompanying requirement for substantial investment in large capital equipment in order to utilize the technology. Investigations that were, for most, unreachable luxuries just a few years ago (individual genome sequencing, metagenomics studies, and the sequencing of myriad organisms of interest) are being increasingly enabled, at a rapid pace.

However, many improvements are still needed in the area of DNA sequencing and DNA sequencing detection.

### BRIEF DESCRIPTION OF THE DRAWINGS

FIG. 1A is a general schematic for photoinduced redox current (PIRC) analysis, in accordance with an embodiment of the present invention.

FIG. 1B is a general schematic for PIRC analysis performed in a bio-reaction chamber, in accordance with an embodiment of the present invention.

FIG. 2 illustrates a sensor or transducer array for PIRC analysis, in accordance with an embodiment of the present invention.

FIG. 3 illustrates a schematic of PIRC analysis for a DNA sequencing application, in accordance with an embodiment of the present invention.

FIG. 4 illustrates a basic scheme of incorporated nucleotide detection by PIRC signal generation and detection on a transducer surface, in accordance with an embodiment of the present invention.

FIG. 5 is a schematic illustrating functional structure properties of photosensitizer-tagged nucleotides, in accordance with an embodiment of the present invention.

FIG. 6 illustrates a structure of a cleavable nucleotide analog structure, in accordance with an embodiment of the present invention.

FIGS. 7A and 7B provide examples of structures of nucleotide analog structures, in accordance with an embodiment of the present invention.

FIG. 8 illustrates a computing device in accordance with one implementation of the invention.

FIG. 9 illustrates a block diagram of an exemplary computer system, in accordance with an embodiment of the present invention.

### DESCRIPTION OF THE EMBODIMENTS

Photoinduced redox current (PIRC) detection for DNA sequencing using integrated transducer arrays is described. In the following description, numerous specific details are set forth, such as detection approaches, in order to provide a thorough understanding of embodiments of the present invention. It will be apparent to one skilled in the art that embodiments of the present invention may be practiced without these specific details. In other instances, well-known features, such as integrated circuit design layouts, are not described in detail in order to not unnecessarily obscure embodiments of the present invention. Furthermore, it is to be understood that the various embodiments shown in the Figures are illustrative representations and are not necessarily drawn to scale.

One or more embodiments are targeted to DNA sequencing using electrical detection technology. Embodiments may address approaches for providing a compact DNA sequencing platform suitable to perform highly sensitive signal detection in a highly parallel fashion. Furthermore, one or more embodiments provide a cost effective and accurate sequencing system to enable wide applications of genomic information for the improvement of human health.

Conventional DNA sequencing technology can be used to decode an individual's genomic DNA sequence of over 6 billion nucleotide bases. However, the total cost of DNA sequencing remains prohibitive at least in part due to complex instrumentation and costly consumables. For routine biomedical analyses, a DNA sequencing platform needs to be compact, sensitive, accurate and exhibit high throughput such that the overall cost is affordable.

Currently, there is not a single DNA sequencing platform that is compact, sensitive, accurate and exhibits high throughput. Existing solutions, instead, address only some of these attributes. As a first example, fluorescent labeling and detection is a very popular approach that relies on fluorescent tagging of nucleotides (DNA building blocks) and fluorescence detection. Although widely adopted, optical detection approaches can have drawbacks such as being bulky and costly, especially when single molecule detection is involved. The approach is accurate, but instrument size is large and expensive. As a second example, ionic charge-based electrical detection is an approach where signals indicate changes of ionic charges caused by biochemical reactions. In one such case, positively charged protons or negatively charged phosphates are generated in DNA polymerase reactions. CMOS technology has been used for ionic charge-based electrical detection (e.g., field effect transistor (FET) based sensing). However, although such an approach can provide compact instrument size, both detection sensitivity and accuracy are relatively low since water molecules and salts in biochemical reactions can be ionized and thus contribute to high noise backgrounds. As a third example, current blockage and tunneling is an approach that involves the use of nanopores for DNA sequencing, especially single DNA molecule sequencing. The approach can be based on either current blockage by passing nucleotide bases or tunneling current across nucleotides bases. Although progress has been made in this area, nanopore sequencing technology is not yet ready for practical use primarily due to low accuracy and limited capability of performing highly parallel operations.

Overall, in accordance with an embodiment of the present invention, approaches described herein involve the use of light sensitive complexes (e.g., photosensitizers) as biomolecular tags for DNA nucleotides (e.g., for DNA building blocks having a total of 4 types: A, T, C, G). The tagged nucleotides are used as labels to identify corresponding complementary nucleotides through direct electrical sensing by an integrated sensor array.

Unlike fluorescent dye tagging approaches where fluorescence is detected when dye molecules are excited by light, embodiments described herein involve photosensitizer tagging to allow direct electrical signal detection upon exciting the photosensitizer tags by light. As a comparison to previous approaches, the direct detection of light induced electron transfer described herein, versus conventional detection of photons emitted during electron energy level decay, does not require complex and bulky optics as in the case of fluorescence detection.

Signal generation approaches for embodiments described herein may be understood in comparison to the mechanism of a dye sensitizer solar cell (DSSC). Specifically, when light excites photosensitizer molecules, excitons are generated and electrons are extracted (e.g., separated) by high bandgap semiconductor materials. In specific embodiments herein, the extracted (separated) electrons are used as signals to indicate the presence of photosensitizer-tagged nucleotides. The electrical current ultimately detected depends on properties and quantities of photosensitizer molecules, which is in turn determined by biochemical reactions, such as DNA sequencing reactions.

However, embodiments described herein differ from DSSC in at least several ways. The photo-induced electrical current described herein is generated in defined molecule structures on a molecular scale, not random aggregates on a macroscale as is the case for DSSC. Reactions are performed in aqueous and biocompatible environments, rather than in organic solvent environment as is the case for DSSC. The electrical signal is used as indicator for the presence or quantification of bio molecules (or DNA base), instead of generating power for generic/undefined uses as is the case for DSSC. All electrical current generation units are operated in parallel, not in tandem as is the case for DSSC.

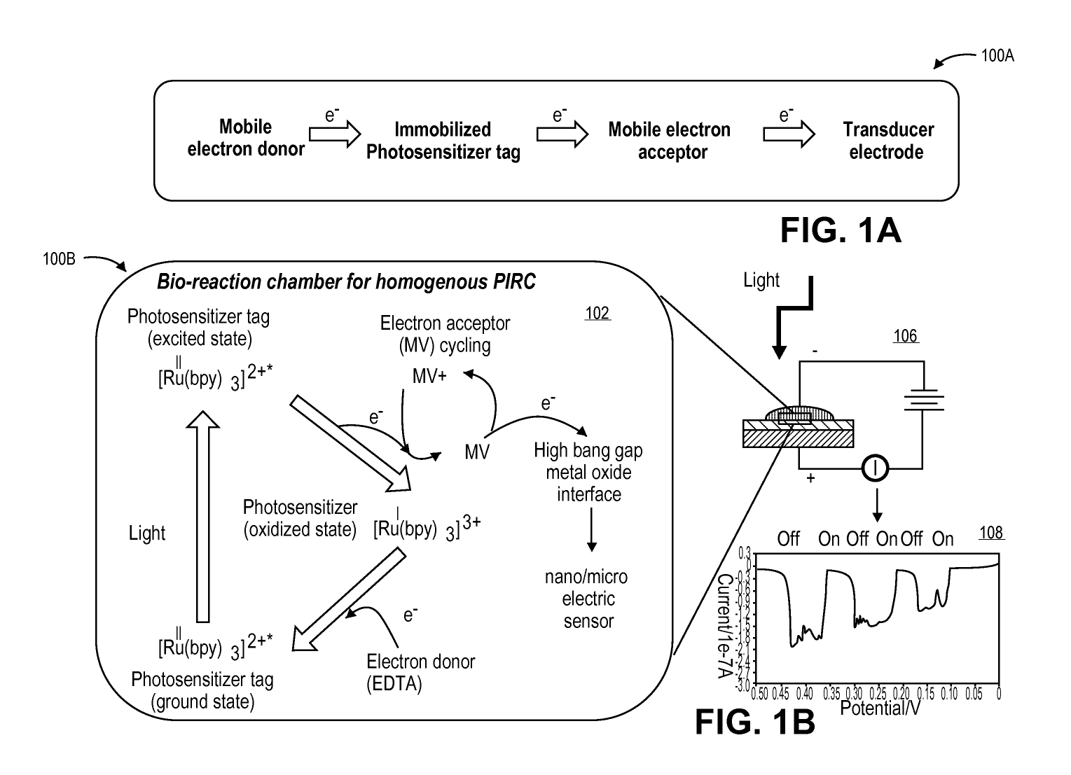

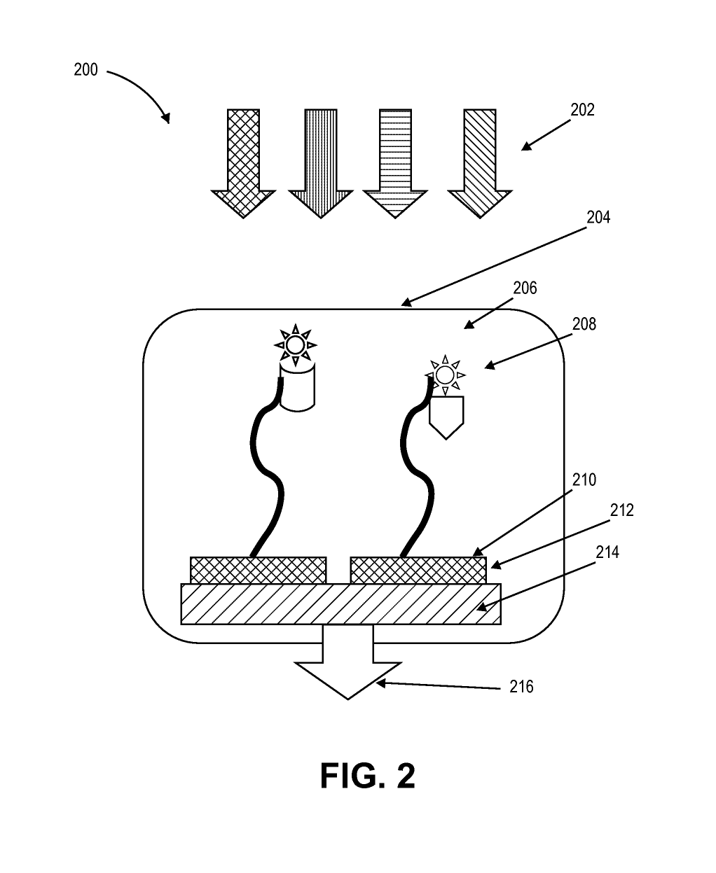

To illustrate concepts described herein, FIG. 1A is a general schematic 100A for photoinduced redox current (PIRC) analysis, while FIG. 1B is a general schematic 100B for PIRC analysis performed in a bio-reaction chamber, in accordance with an embodiment of the present invention. Referring to schematic 100A, a mobile electron donor transfers an electron to an immobilized photosensitizer tag. The immobilized photosensitizer tag transfers an electron to a mobile electron acceptor. The mobile electron acceptor then transfers an electron to a transducer electrode for detection. Schematic 100B illustrates an example (based on Ru(bpy)₃ species) of the transfer mechanisms as performed in a chamber 102 amenable to a light source 104 an electrically coupled to a detector circuit 106. The detector circuit 106 can be coupled to a display 208 for detection purposes, as shown in FIG. 1B.

In more specific embodiments, approaches for detection described herein can involve the use of one or more new detection aspects. In a first aspect involving chemical composition, photosensitizers are used as tags to label nucleotides, e.g., for photoinduced current generation from DNA molecules. In a second aspect involving signal generation, one or more photoinduced current generation reactions are performed in a biochemical reaction chamber to generate bio-analyte relevant information (e.g., DNA sequencing). In a third aspect involving signal detection, photosensitizer sensor arrays (e.g., redox transducer arrays) are integrated with a complimentary metal oxide semiconductor (CMOS) based integrated circuit for massively parallel biochemical analysis. In a fourth aspect involving applications, light induced redox current is correlated with bioanalytes (e.g., DNA bases).

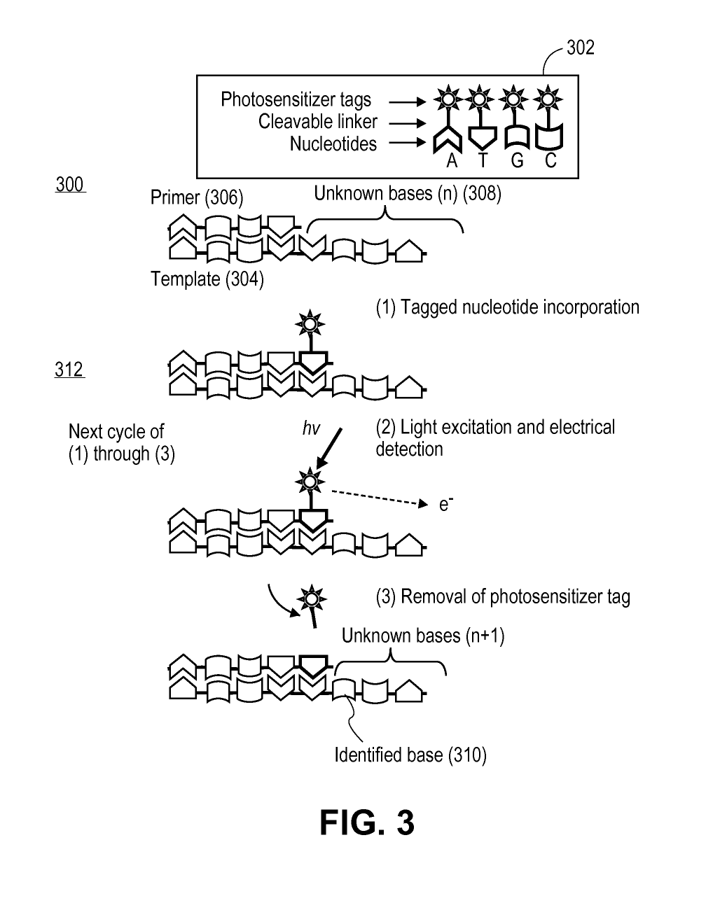

In a structural aspect of one or more embodiments of the present invention, basic system structure and components can include one or more of the following: (a) one or more light sources (e.g., mono- or poly-chromes), (b) a transparent enclosure, (c) a reaction chamber for multiplex biochemical reactions, (d) a set of photosensitizer-tagged nucleotides that can be incorporated with immobilized DNA molecules, (e) a functional surface for nucleic acid attachment, (f) a high bang gap metal oxide for use as a transducer interface, (g) integrated CMOS circuitry for signal processing, and/or (h) a data output interface. As an illustrative example, FIG. 2 represents a sensor array 300 for PIRC analysis, in accordance with an embodiment of the present invention. The sensor array 200 includes one or more of light sources 202 (e.g., mono- or poly-chromes), a transparent enclosure 204, a reaction chamber 206 for multiplex biochemical reactions, at least one photosensitizer molecule 208 immobilized to one biomolecule (1:1), a functional surface 210 for nucleic acid attachment, a high bang gap metal oxide 212 as a transducer interface, integrated CMOS circuitry 214 for signal processing, and a data output interface 216. In one embodiment, the reaction chamber is further coupled to a fluidic system and/or a temperature control system (not shown).

Referring again to FIG. 2, additional or alternative embodiments may also be implemented. For example, although the light source is depicted as being outside of the reaction chamber 206, in another embodiment, a light source is included inside the reaction chamber 206. In a specific such embodiment, a light emitting diode (LED) is integrated with the transducer array. In another embodiment, multiple light sources (e.g., having different wavelengths) can be included for use with nucleotides each tagged with different photosensitizers that are incorporated to different priming strands on different DNA templates in a one step reaction. In one such embodiment, light sources are sequentially turned on to identify the location of activated transducers, in order to determine the states of multiple DNA templates simultaneously.

It is to be understood that the integrated transducer array is not limited to a CMOS sensor array. Additionally, in general, the transducer interface can be conductive or semiconductive, and is not limited to a high band gap oxide. For example, the functional interface can be composed of conductive metals (e.g., Au, Ag, Pt, or metal alloys), conductive carbon materials (e.g., doped diamonds), semiconductor materials (e.g., TiO₂, ITO, Ta₂O₅, ZnO, etc.). In one embodiment, the transducer interface is composed of a material such as, but not limited to, a metal, a conductive carbon material, a semiconductor material, a high band gap metal oxide material, or an organic semiconductor material.

Advantages of one or more embodiments include use of a compact apparatus size for massively parallel reactions and high sensitivity for accurate signal detections. High sensitivity is attributed to the signal amplification nature of photoinduced current generation since each individual photosensitizer molecule can potentially generate millions of extractable electrons. Compact size and parallelism are enabled by microfabrication technology for both the electronic circuitry and the transducer array.

More specifically, in an embodiment, when approaches described herein are applied to DNA sequencing, one or more additional advantages can be realized. In a first aspect, improved detection performance can be achieved based on an improved signal/noise ratio. For example, a signal can be amplified due to photo induced current generation (e.g., millions of electrons from one photosensitizer molecule), while low noise is achieved through one or both of (a) miniaturizing and integrating electronic components and (b) light activated oxidation of stable electron donors (e.g., the use of compounds having a high redox potential). In a second aspect, improved efficiency can be realized since microfabrication technologies are used to build an integrated CMOS-transducer array, with millions to billions of transducers constructed in a single chip. Such microfabrication technologies can include inorganic CMOS technology or organic semiconductor technology. These approaches provide high throughput capability in that more data can be generated per unit time using a single chip. Furthermore, smaller sample size and a lower amount of reagents are needed. Overall, high efficiency and throughput eventually lead to lower operation cost. In a third aspect, broad applications may be realized since a reduced system dimension enables compact system or portability. Compact system size and/or portability can, in turn, facilitate applicability to more biomedical applications, such as DNA sequencing for regular cancer diagnosis and treatment monitoring, e.g., since cancers cells are known to have altered genome structure (DNA) and abnormal gene expression (RNA). In a fourth aspect, lower cost and increased use affordability can be realized since sensor arrays built on CMOS chips can perform highly parallel molecular detections. Additionally, chip manufacturing can be scaled to high volume production. Both attributes can be used to reduce the cost per unit of data to be generated. By contrast, a highly sensitive optical detection system may not be suitable for miniaturization, especially since lower temperature cooling to lower electronic noise is one of many limiting factors for optical approaches.

As an overview of a general procedure, in accordance with one or more embodiments of the present invention, a DNA sequencing approach includes one or more of the following operations. Although listed numerically for clarity, it is to be understood that specific operation ordering may be rearranged. Also, some operations may be removed while other operations not listed may be included. In a first operation, a set of nucleotides is provided. The nucleotide bases are tagged with photosensitizers (e.g., dye-sensitizers). In a second operation, a sequencing chip is provided. The sequencing chip includes one or more (or all) of (a) a set of micro electrodes (e.g., a transducer array), (b) a CMOS circuit that is structurally integrated with the transducer array, (c) and a surface for DNA target molecule attachment that is part of the transducer array and is open to the reaction chamber. In a third operation, DNA target molecules are attached on the transducer array surface. In a fourth operation, DNA polymerase reactions are carried out in the presence of photosensitizer-tagged nucleotides in the reaction chamber with the transducer array exposed. In a fifth operation, free photosensitizer-tagged nucleotides are removed. In a sixth operation, the transducer surface is exposed to light and the resulting electrical signals are detected. The fourth through sixth operations can then be repeated for multiple cycles, as needed.

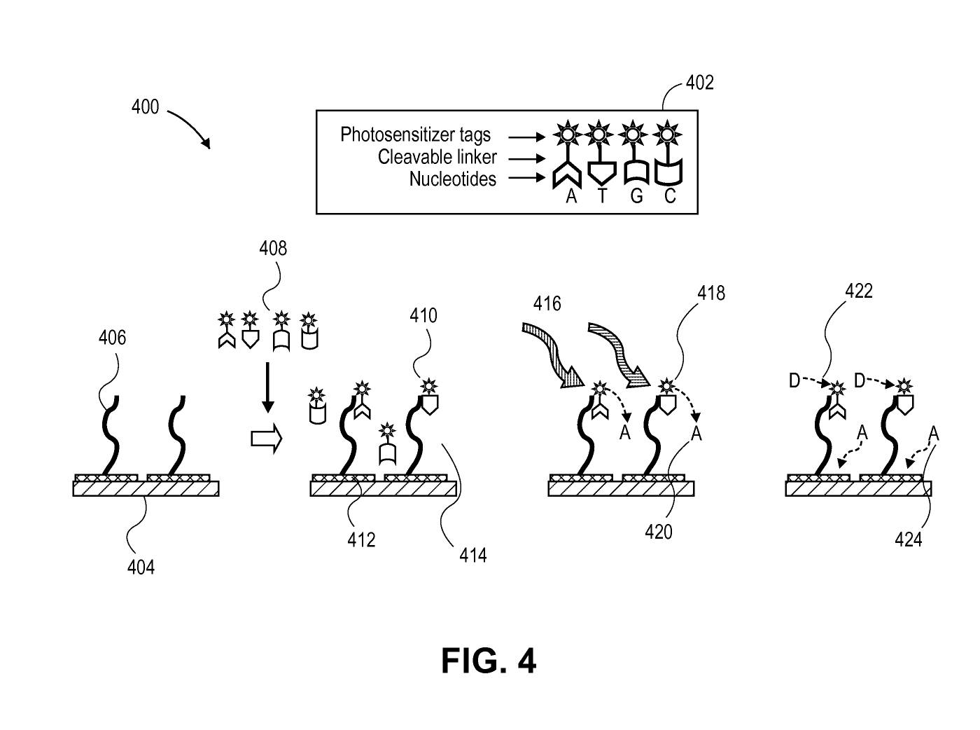

In a more specific example, FIG. 3 illustrates a schematic 300 of PIRC analysis for a DNA sequencing application, in accordance with an embodiment of the present invention. Referring to schematic 300, a variety of relationships 302 of photo-sensitizer tags, cleavable linkers and nucleotides based on A, T, G or C is provided. The relationships can be exploited for detection where a template 304 having primers 306 and “n” unknown base locations 308 is subjected to a first operation of tagged nucleotide incorporation. A second operation of light excitation and electrical detection is then performed. The photosensitizer tag is then removed in a third operation, providing an identified base 310 and one less unknown bases (n−1). The three operations can then be repeated to indentify further bases, as indicated by arrow 312. It is to be understood that, typically, a template includes both a primer region and an unknown region. A primer is annealed to the primer region, and nucleotide is added (e.g., incorporated) to the primer (priming strand) and newly incorporated nucleotide (base) is complementary to the base in the template strand. It is also to be understood that DNA templates do not have to be immobilized on the transducer surface directly, so long as immobilizing is proximate. It is to be further understood that the template can also be referred to as a nucleic acid template.

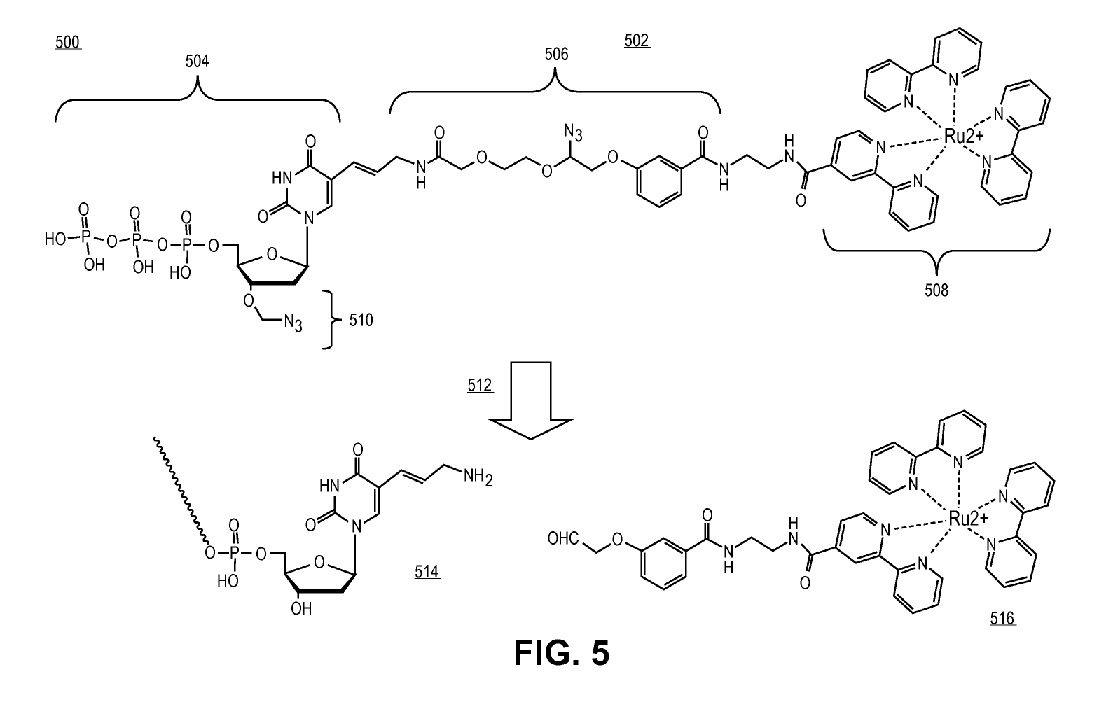

FIG. 4 illustrates a basic scheme 400 of incorporated nucleotide detection by PIRC signal generation and detection on a transducer surface, in accordance with an embodiment of the present invention. Referring to FIG. 4, a variety of relationships 402 of photo-sensitizer tags, cleavable linkers and nucleotides based on A, T, G or C is provided. At a first operation, an integrated sensor array 404 has immobilized DNA molecules 406 thereon. Photo-sensitizer tagged nucleotides 408 are provided at a second operation. A photosensitizer may be incorporated 410 to provide a transducer device 412 in a reaction chamber 414 at a third operation. At a fourth operation, a light source 416 may be used to provide an excited photosensitizer 418 and a reduced electron acceptor 520. At a fifth operation, oxidation of an electron donor by a photodesensitizer 422 provides electron transfer from an acceptor to a high band gap metal oxide interface (e.g., transducer) at 424.

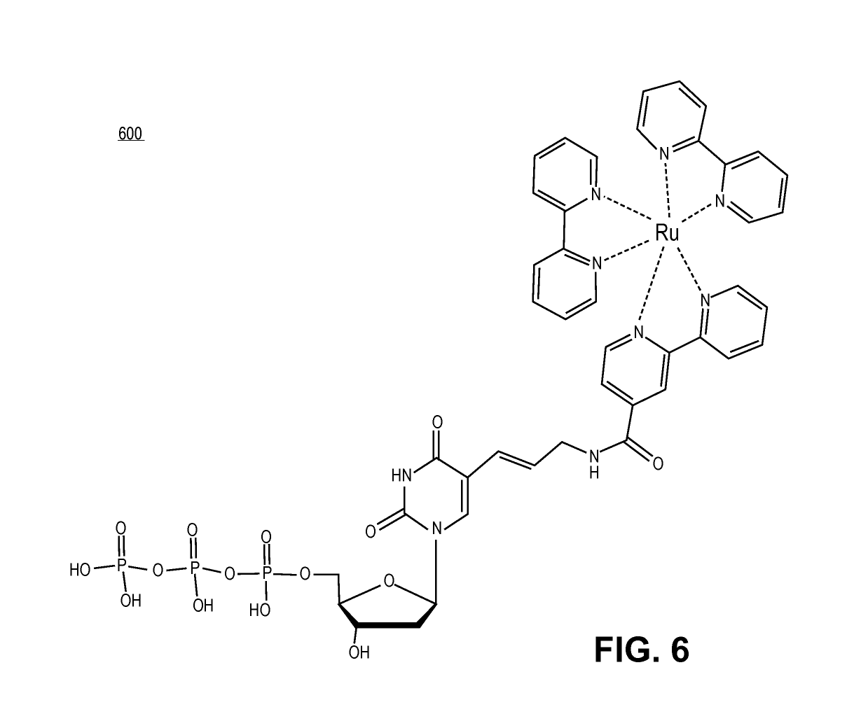

FIG. 5 is a schematic 500 illustrating functional structure properties of photosensitizer-tagged nucleotides, in accordance with an embodiment of the present invention. Referring to schematic 500, photosensitizer cleavage is shown as applicable in a DNA sequencing scheme. As an example, a photosensitizer-tagged nucleotide 502 includes a nucleotide triphosphate portion 504, a cleavable linker 506, and a photosensitizer tag 508, e.g., Ru(Bpy)₃²⁺. Also included is a cleavable terminator 510. By subjecting the photosensitizer-tagged nucleotide 502 to incorporation in a polymerase reaction, photoinduced electrical signal detection, and cleavage of the photosensitizer and terminator from an incorporated nucleotide, as indicated by arrow 512, an incorporated, deprotected and tag-free nucleotide 514 and cleaved photosensitizer 516 are provided.

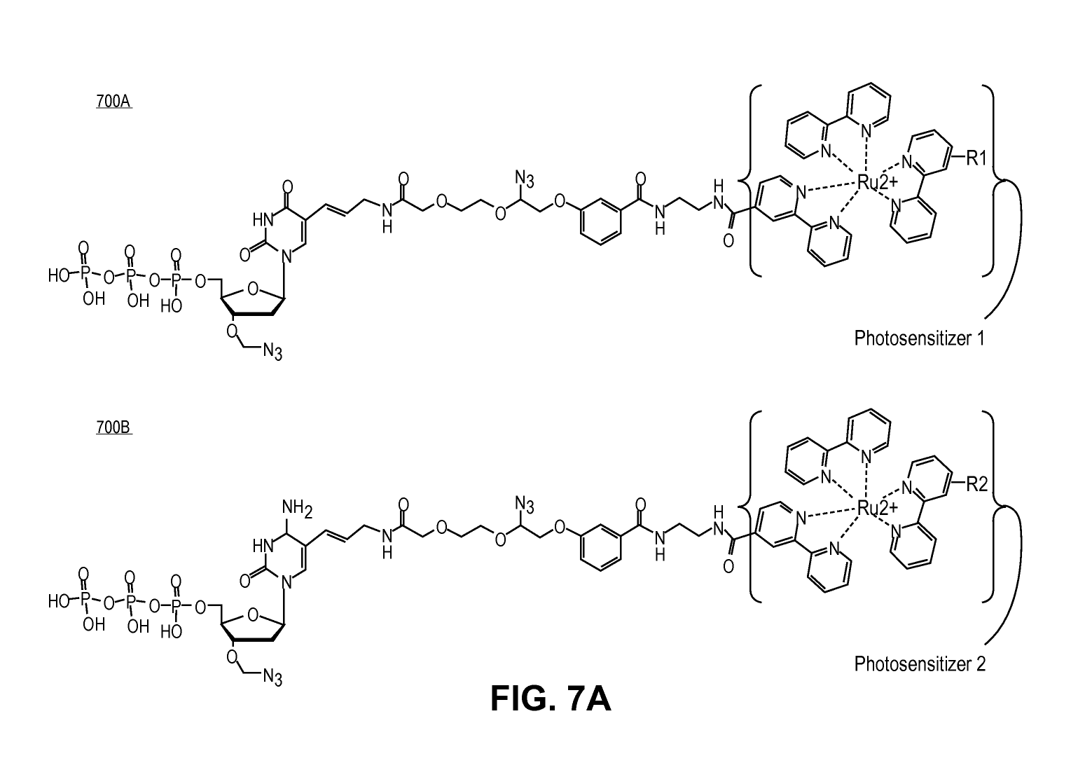

As an example, FIG. 6 illustrates a structure 600 of a cleavable nucleotide analog structure, in accordance with an embodiment of the present invention. Referring to FIG. 6, the structure 600 of 5-ruthenium (tris-bipyridyl)-amido-allyl-dUTP is provided. In an example, synthesis of 5-ruthenium (tris-bipyridyl)-amido-allyl-dUTP involves: aminoallyl-dUTP (1.0 micromole) was dissolved in 10 microliters of water, and freshly made saturated sodium bicarbonate (5 microliters) was added. To this buffered solution, ruthenium-tris-bipyridyl complex NHS ester (5 mg) in 10 microliters of anhydrous DMSO was added dropwise with vortexing to mix. The ruthenium-tris-bipyridyl complex NHS ester might precipitate out during the addition. The mixture became a clear solution after 10 minutes with vortexing. The solution was incubated at room temperature for one more hour after addition. LC-MS was used to monitor the reaction for completion. The reaction solution was then transferred into 1 milliliter of water and then loaded on a preparative HPLC with a C18 column for purification. The yield is 80% based on the aminoallyl-dUTP.

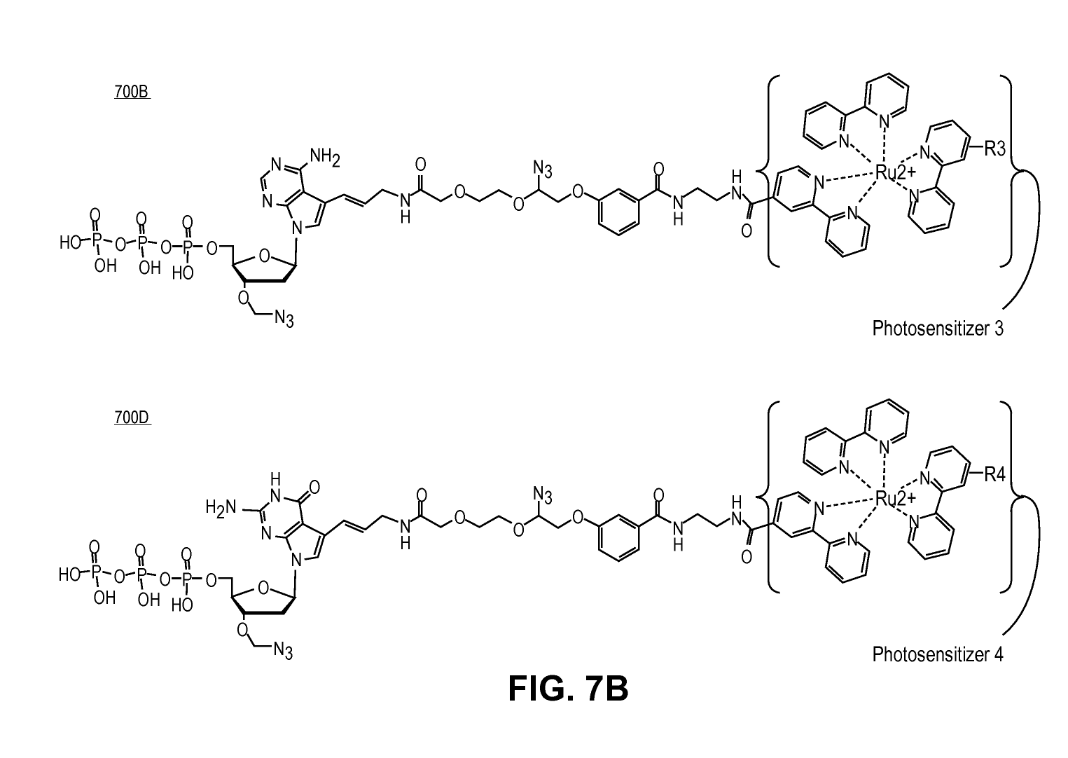

As another example, FIGS. 7A and 7B illustrates structures 700A, 700B, 700C and 700D of nucleotide analog structures, in accordance with an embodiment of the present invention. Referring to FIGS. 7A and 7B, nucleotides can be tagged with unique photosensitizers. For example, nucleotides 700A (cleavable ruthenium, reversible dTTP), 700B (cleavable ruthenium, reversible dCTP), 700C (cleavable ruthenium, reversible dATP) and 700D (cleavable ruthenium, reversible dGTP) are tagged with R1, R2, R3 and R4, respectively, which are four chemical groups of unique optical absorption property. The examples of FIG. 7 may be suitable for DNA detection in accordance with one or more embodiments described herein.

To provide a general context, overall, one or more embodiments are directed to performing DNA sequencing based on photoinduced electrical signal detection. An integrated electronic circuit can be used to detect photoinduced current for DNA sequencing applications. The combination of the chemistry scheme with CMOS integrated circuits (ICs) and sequencing applications provides advantages not previously realized in conventional detection approaches. Furthermore, CMOS IC chips can be used for massive human genome sequence information generation, which can leverage advanced fabrication technology.

As used herein, “sensor” or “transducer” refers to a substance or device that detects or senses an electrical signal created by movement of electrons, including but not limited to electrical resistance, current, voltage and capacitance. That is, the transducer or sensor can detect signals in the form of current, or detect voltage, or impedance or magnetic field, or a combination thereof. A transducer array has one or more transducers, up to billions of transducers.

An “array” is an intentionally created collection of substances, such as molecules, openings, microcoils, detectors and/or sensors (or transducers), attached to or fabricated on a substrate or solid surface, such as glass, plastic, silicon-chip, IC chip or other material forming an array. The arrays (such as sensor/transducer arrays) can be used to measure the signal locations and levels of large numbers, e.g., tens, thousands, millions, or billions of reactions or combinations simultaneously. An array may also contain a small number of substances, e.g., a few or a dozen. The substances in the array can be identical or different from each other. The array can assume a variety of formats, e.g., libraries of soluble molecules; libraries of compounds tethered to resin beads, silica chips, or other solid supports. The array could either be a macroarray or a microarray, depending on the size of the pads (features) on the array. A macroarray generally contains pad (feature) sizes of about 300 microns or as small as 1 micron, or even 0.1 micron. A sensor array would generally contain pad sizes of less than 300 microns. Sensing elements (e.g., sensor array features or sensor pads) of the sensor/transducer array can be electronically individually addressable.

The term “reagent mixture” represents a composition having several components such as, but not limited to, DNA polymerase, nucleotides, salt (e.g., MG2+, K+ or Na+), buffers, etc. The reagent mixture may also include an analyte. The term “analyte” refers to a molecule of interest that is to be detected and/or analyzed, e.g., a nucleotide, an oligonucleotide, a polynucleotide, a peptide, or a protein. The analyte, target or target molecule could be a small molecule, biomolecule, or nanomaterial such as but not necessarily limited to a small molecule that is biologically active, nucleic acids and their sequences, peptides and polypeptides, as well as nanostructure materials chemically modified with biomolecules or small molecules capable of binding to molecular probes such as chemically modified carbon nanotubes, carbon nanotube bundles, nanowires, nanoclusters or nanoparticles. The target molecule may be a fluorescently labeled antigen, antibody, DNA or RNA. A “bioanalyte” refers to an analyte that is a biomolecule. Specifically, analytes for DNA sequencing can be samples containing nucleic acid molecules, such as genomic or synthetic, or biochemically amplified DNA or cDNA. “Analyte” molecule can be used interchangeably with “ target” molecule.

The terms “tag” and “label” are used to refer to a marker or indicator distinguishable by the observer but not necessarily by the system used to identify an analyte or target. A tag may also achieve its effect by undergoing a pre-designed detectable process. Tags are often used in biological assays to be conjugated with, or attached to, an otherwise difficult to detect substance. At the same time, tags usually do not change or affect the underlining assay process. A tag used in biological assays include, but not limited to, a radio-active material, a magnetic material, quantum dot, an enzyme, a liposome-based label, a chromophore, a fluorophore, a dye, a nanoparticle, a quantum dot or quantum well, a composite-organic-inorganic nano-cluster, a colloidal metal particle, or a combination thereof. In one embodiment, a tag or a label is preferably a metal-organic complex that can be induced to generate electron current upon light exposure.

The term “nucleotide” includes deoxynucleotides and analogs thereof. These analogs are those molecules having some structural features in common with a naturally occurring nucleotide such that when incorporated into a polynucleotide sequence, they allow hybridization with a complementary polynucleotide in solution. Typically, these analogs are derived from naturally occurring nucleotides by replacing and/or modifying the base, the ribose or the phosphodiester moiety. The changes can be tailor-made to stabilize or destabilize hybrid formation, or to enhance the specificity of hybridization with a complementary polynucleotide sequence as desired, or to enhance stability of the polynucleotide.

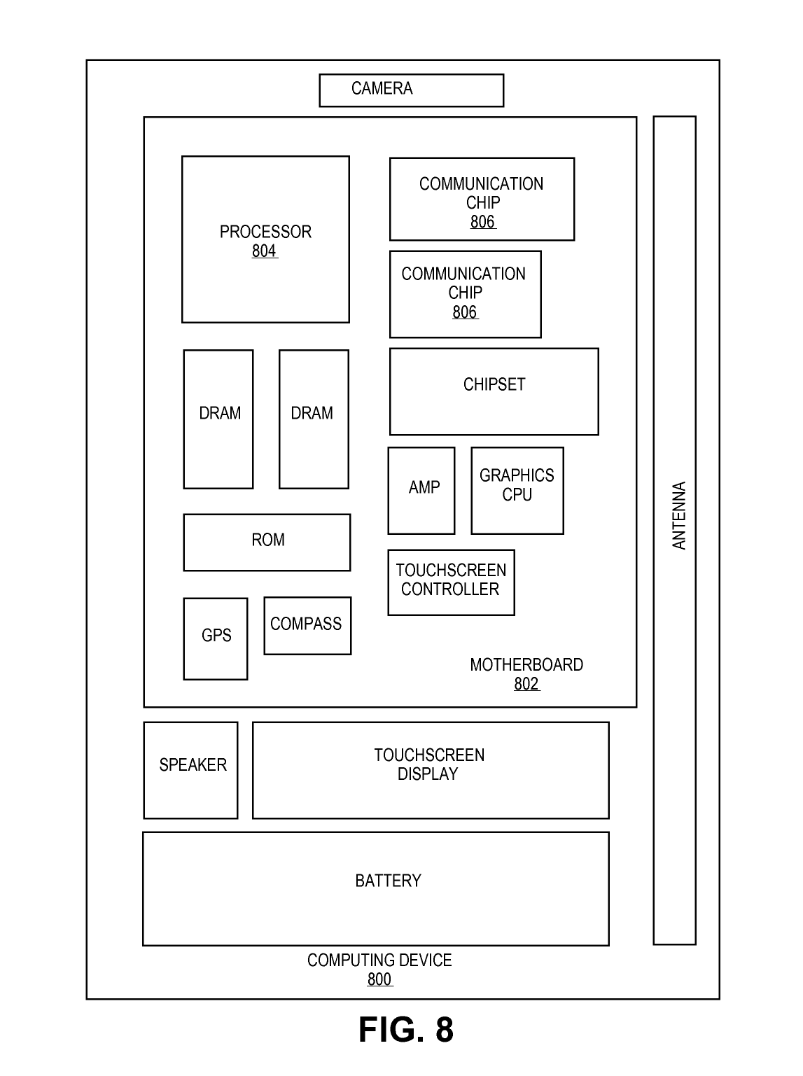

FIG. 8 illustrates a computing device 800 in accordance with one implementation of the invention. The computing device 800 houses a board 802. The board 802 may include a number of components, including but not limited to a processor 804 and at least one communication chip 806. The processor 804 is physically and electrically coupled to the board 802. In some implementations the at least one communication chip 806 is also physically and electrically coupled to the board 802. In further implementations, the communication chip 806 is part of the processor 804.

Depending on its applications, computing device 800 may include other components that may or may not be physically and electrically coupled to the board 802. These other components include, but are not limited to, volatile memory (e.g., DRAM), non-volatile memory (e.g., ROM), flash memory, a graphics processor, a digital signal processor, a crypto processor, a chipset, an antenna, a display, a touchscreen display, a touchscreen controller, a battery, an audio codec, a video codec, a power amplifier, a global positioning system (GPS) device, a compass, an accelerometer, a gyroscope, a speaker, a camera, and a mass storage device (such as hard disk drive, compact disk (CD), digital versatile disk (DVD), and so forth).

The communication chip 806 enables wireless communications for the transfer of data to and from the computing device 800. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication chip 806 may implement any of a number of wireless standards or protocols, including but not limited to Wi-Fi (IEEE 802.11 family), WiMAX (IEEE 802.16 family), IEEE 802.20, long term evolution (LTE), Ev-DO, HSPA+, HSDPA+, HSUPA+, EDGE, GSM, GPRS, CDMA, TDMA, DECT, Bluetooth, derivatives thereof, as well as any other wireless protocols that are designated as 3G, 4G, 5G, and beyond. The computing device 800 may include a plurality of communication chips 806. For instance, a first communication chip 806 may be dedicated to shorter range wireless communications such as Wi-Fi and Bluetooth and a second communication chip 806 may be dedicated to longer range wireless communications such as GPS, EDGE, GPRS, CDMA, WiMAX, LTE, Ev-DO, and others.

The processor 804 of the computing device 800 includes an integrated circuit die packaged within the processor 804. In some implementations of the invention, the integrated circuit die of the processor includes or is coupled to an integrated transducer array, in accordance with implementations of the invention. The term “processor” may refer to any device or portion of a device that processes electronic data from registers and/or memory to transform that electronic data into other electronic data that may be stored in registers and/or memory.

The communication chip 806 also includes an integrated circuit die packaged within the communication chip 806. In accordance with another implementation of the invention, the integrated circuit die of the communication chip includes or is coupled with an integrated transducer array in accordance with implementations of the invention.

In further implementations, another component housed within the computing device 800 may contain an integrated circuit die that includes or is coupled with an integrated transducer array in accordance with implementations of the invention.

In various implementations, the computing device 800 may be a laptop, a netbook, a notebook, an ultrabook, a smartphone, a tablet, a personal digital assistant (PDA), an ultra mobile PC, a mobile phone, a desktop computer, a server, a printer, a scanner, a monitor, a set-top box, an entertainment control unit, a digital camera, a portable music player, or a digital video recorder. In further implementations, the computing device 800 may be any other electronic device that processes data.

Embodiments of the present invention may be provided as a computer program product, or software, that may include a machine-readable medium having stored thereon instructions, which may be used to program a computer system (or other electronic devices) to perform a process according to the present invention. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices, etc.), a machine (e.g., computer) readable transmission medium (electrical, optical, acoustical or other form of propagated signals (e.g., infrared signals, digital signals, etc.)), etc.

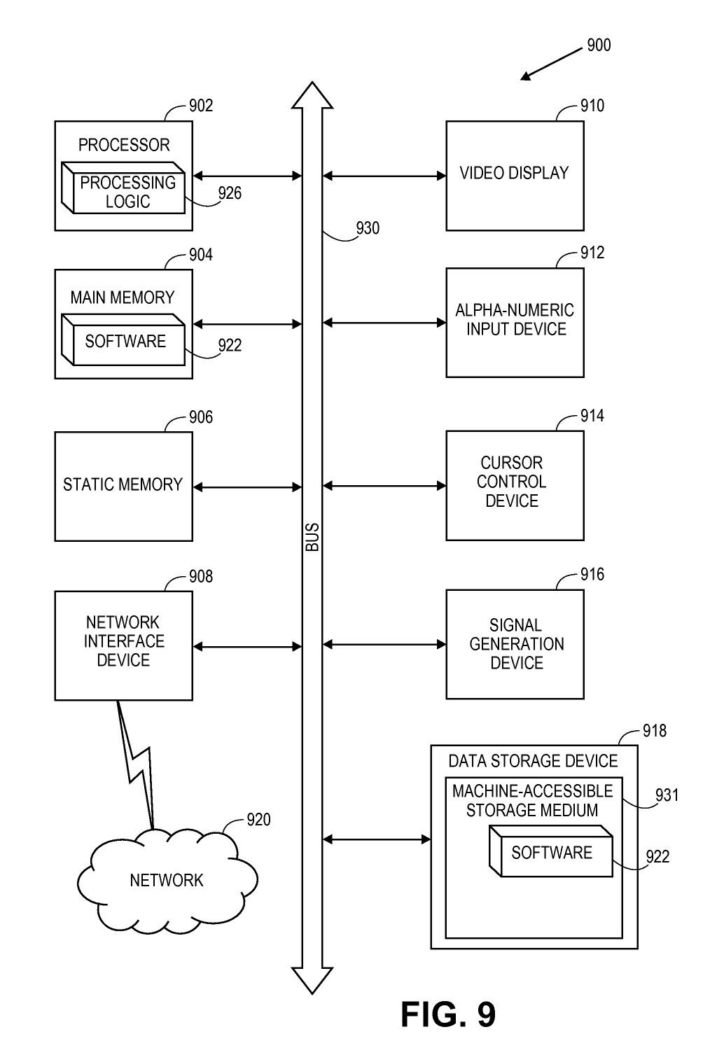

FIG. 9 illustrates a diagrammatic representation of a machine in the exemplary form of a computer system 900 within which a set of instructions, for causing the machine to perform any one or more of the methodologies discussed herein, may be executed. In alternative embodiments, the machine may be connected (e.g., networked) to other machines in a Local Area Network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

The exemplary computer system 900 includes a processor 902, a main memory 904 (e.g., read-only memory (ROM), flash memory, dynamic random access memory (DRAM) such as synchronous DRAM (SDRAM) or Rambus DRAM (RDRAM), etc.), a static memory 906 (e.g., flash memory, static random access memory (SRAM), etc.), and a secondary memory 918 (e.g., a data storage device), which communicate with each other via a bus 930.

Processor 902 represents one or more general-purpose processing devices such as a microprocessor, central processing unit, or the like. More particularly, the processor 902 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processor 902 may also be one or more special-purpose processing devices such as an application specific integrated circuit (ASIC), a field programmable gate array (FPGA), a digital signal processor (DSP), network processor, or the like. Processor 902 is configured to execute the processing logic 926 for performing the operations discussed herein.

The computer system 900 may further include a network interface device 908. The computer system 900 also may include a video display unit 910 (e.g., a liquid crystal display (LCD) or a cathode ray tube (CRT)), an alphanumeric input device 912 (e.g., a keyboard), a cursor control device 914 (e.g., a mouse), and a signal generation device 916 (e.g., a speaker).

The secondary memory 918 may include a machine-accessible storage medium (or more specifically a computer-readable storage medium) 931 on which is stored one or more sets of instructions (e.g., software 922) embodying any one or more of the methodologies or functions described herein. The software 922 may also reside, completely or at least partially, within the main memory 904 and/or within the processor 902 during execution thereof by the computer system 900, the main memory 904 and the processor 902 also constituting machine-readable storage media. The software 922 may further be transmitted or received over a network 920 via the network interface device 908.

While the machine-accessible storage medium 931 is shown in an exemplary embodiment to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine to perform any one or more of the methodologies of the present invention. The term “machine-readable storage medium” shall accordingly be taken to include, but not be limited to, solid-state memories, and optical and magnetic media.

Thus, embodiments of the present invention include photoinduced redox current (PIRC) detection for DNA sequencing using integrated transducer arrays.

In an embodiment, a method of determining DNA sequencing using photoinduced redox current (PIRC) includes providing a template having a primer region and a second region of one or more unknown bases. The template is coupled to a transducer array. The method also includes incorporating a tagged nucleotide at the second region of the template. The method also includes exposing the template to a light source. The method also includes electrically detecting, by the transducer, a state of the template. The method also includes removing a photosensitizer tag of the tagged nucleotide.

In one embodiment, incorporating the tagged nucleotide involves immobilizing the tagged nucleotide at the second region of the template.

In one embodiment, electrically detecting the state of the template by the transducer involves measuring using a complimentary metal oxide semiconductor (CMOS) sensor array.

In one embodiment, exposing the tagged nucleotide to the light source involves exciting the photosensitizer tag of the tagged nucleotide.

In one embodiment, exciting the photosensitizer tag of the tagged nucleotide involves ejecting an electron from the photosensitizer tag to an electron acceptor.

In one embodiment, the ejecting the electron from the photosensitizer tag involves detecting using a complimentary metal oxide semiconductor (CMOS) sensor array.

In one embodiment, electrically detecting the state of the template involves determining one of the unknown bases of the second region to establish a known base.

In one embodiment, the method further includes, subsequent to removing the photosensitizer tag of the tagged nucleotide, incorporating a second tagged nucleotide at the second region of the template, exposing the template to the light source, electrically detecting, by the transducer, a state of the template, and removing a photosensitizer tag of the second tagged nucleotide.

In one embodiment, electrically detecting the state of the template involves determining a second of the unknown bases of the second region to establish a second known base.

In one embodiment, the incorporating the tagged nucleotide at the second region of the template is performed prior to the exposing the tagged nucleotide to the light source, which is performed prior to the electrically detecting the state of the template by the transducer, which is performed prior to the removing the photosensitizer tag of the tagged nucleotide.

In an embodiment, a method of determining DNA sequencing using photoinduced redox current (PIRC) includes providing an integrated transducer array having a plurality of immobilized DNA molecules thereon. The method also includes delivering a reagent mixture comprising a plurality of photo-sensitizer tagged nucleotides to the integrated transducer array, in contact with the plurality of immobilized DNA molecules. The method also includes exposing the integrated transducer array to a light source. The method also includes electrically detecting a state of the immobilized DNA molecules with the integrated transducer array.

In one embodiment, the integrated transducer array is a complimentary metal oxide semiconductor (CMOS) sensor array

In one embodiment, delivering the reagent mixture involves incorporating one or more of the plurality photo-sensitizer tagged nucleotides into a corresponding one or more of the plurality of immobilized DNA molecules.

In one embodiment, exposing the integrated transducer array to the light source involves exciting one or more of the plurality of photo-sensitizer tagged nucleotides of the reagent mixture.

In one embodiment, electrically detecting the state of the immobilized DNA molecules involves determining an identity of one or more of the plurality of photo-sensitizer tagged nucleotides.

In one embodiment, the delivering the reagent mixture is performed prior to the exposing the integrated transducer array to the light source, which is performed prior to the electrically detecting the state of the immobilized DNA molecules.

In an embodiment, an apparatus for determining DNA sequencing using photoinduced redox current (PIRC) includes an integrated transducer array. The apparatus also includes a transducer interface disposed on the integrated transducer array, the transducer interface for accepting electrons from incorporated photo-sensitizer tagged nucleotides. The apparatus also includes a light source directed to the transducer interface. The apparatus also includes a reaction chamber housing the integrated transducer array and the transducer interface.

In one embodiment, the integrated transducer array is a complimentary metal oxide semiconductor (CMOS) sensor array.

In one embodiment, the transducer interface is composed of a material such as, but not limited to, a metal, a conductive carbon material, a semiconductor material, a high band gap metal oxide material, or an organic semiconductor material.

In one embodiment, the transducer interface has a functional area for nucleic acid attachment.

In one embodiment, the light source is outside of the reaction chamber, and the reaction chamber includes a transparent enclosure.

In one embodiment, the light source is inside of the reaction chamber.

In one embodiment, the integrated transducer array includes a data output interface.

1. A method of determining DNA sequencing using photoinduced redox current (PIRC), the method comprising:
providing a template having a primer region and a second region of one or more unknown bases, the template coupled to a transducer array;
incorporating a tagged nucleotide at the second region of the template;
exposing the template to a light source;
electrically detecting, by the transducer, a state of the template; and
removing a photosensitizer tag of the tagged nucleotide.

2. The method of claim 1, wherein incorporating the tagged nucleotide comprises immobilizing the tagged nucleotide at the second region of the template.

3. The method of claim 1, wherein electrically detecting the state of the template by the transducer comprises measuring using a complimentary metal oxide semiconductor (CMOS) sensor array.

4. The method of claim 1, wherein exposing the template to the light source comprises exciting the photosensitizer tag of the tagged nucleotide.

5. The method of claim 4, wherein exciting the photosensitizer tag of the tagged nucleotide comprises ejecting an electron from the photosensitizer tag to an electron acceptor.

6. The method of claim 5, wherein the ejecting the electron from the photosensitizer tag comprising detecting using a complimentary metal oxide semiconductor (CMOS) sensor array.

7. The method of claim 1, wherein electrically detecting the state of the template comprises determining one of the unknown bases of the second region to establish a known base.

8. The method of claim 1, further comprising:
subsequent to removing the photosensitizer tag of the tagged nucleotide, incorporating a second tagged nucleotide at the second region of the template;
exposing the template to the light source;
electrically detecting, by the transducer, a state of the template; and
removing a photosensitizer tag of the second tagged nucleotide.

9. The method of claim 8, wherein electrically detecting the state of the template comprises determining a second of the unknown bases of the second region to establish a second known base.

10. The method of claim 1, wherein the incorporating the tagged nucleotide at the second region of the template is performed prior to the exposing the tagged nucleotide to the light source, which is performed prior to the electrically detecting the state of the template by the transducer, which is performed prior to the removing the photosensitizer tag of the tagged nucleotide.

11. A method of determining DNA sequencing using photoinduced redox current (PIRC), the method comprising:
providing an integrated transducer array having a plurality of immobilized DNA molecules thereon;
delivering a reagent mixture comprising a plurality of photo-sensitizer tagged nucleotides to the integrated transducer array, in contact with the plurality of immobilized DNA molecules;
exposing the integrated transducer array to a light source; and
electrically detecting a state of the immobilized DNA molecules with the integrated transducer array.

12. The method of claim 11, wherein the integrated transducer array is a complimentary metal oxide semiconductor (CMOS) sensor array.

13. The method of claim 11, wherein delivering the reagent mixture comprises incorporating one or more of the plurality photo-sensitizer tagged nucleotides into a corresponding one or more of the plurality of immobilized DNA molecules.

14. The method of claim 11, wherein exposing the integrated transducer array to the light source comprises exciting one or more of the plurality of photo-sensitizer tagged nucleotides of the reagent mixture.

15. The method of claim 11, wherein electrically detecting the state of the immobilized DNA molecules comprises determining an identity of one or more of the plurality of photo-sensitizer tagged nucleotides.

16. The method of claim 11, wherein the delivering the reagent mixture is performed prior to the exposing the integrated transducer array to the light source, which is performed prior to the electrically detecting the state of the immobilized DNA molecules.

17.-23. (canceled)
